(19) United States
(12) Patent Application Publication
(10) Pub. No.: US 2006/0011165 A1
(43) Pub. Date: Jan. 19, 2006

(54) Method of operating a spark-ignition internal combustion engine

(76) Inventors: Jürgen Frey, Esslingen (DE); Karl Günter, Esslingen (DE); Roland Kemmler, Stuttgart (DE); Stephan Krämer, Schwaikheim (DE)

Correspondence Address: KLAUS J. BACH, 4407 TWIN OAKS DRIVE, MURRYSVILLE, PA, 15668, US

(21) Appl. No.: 11/208,439

(22) Filed: Aug. 19, 2005

Related U.S. Application Data
(63) Continuation-in-part of application No. PCT/EP03/01432, filed on Dec. 16, 2003.

(30) Foreign Application Priority Data
Feb. 20, 2003 (DE) 103 07 166.0

(51) Int. Cl. F02B 3/00; F02B 7/00; F02M 25/07

(52) U.S. Cl. 123/299; 123/431; 123/568.21

(57) ABSTRACT

In a method for operating a spark-ignition internal combustion engine, wherein fuel is metered into the cylinders by direct fuel injection into the combustion chambers and by the addition of fuel in an intake region of the engine and a control unit matches the quantity of fuel to be added in the intake region and the quantity of fuel to be injected directly into the combustion chamber to one another as a function of the operating point of the internal combustion engine so as to provide an ignitable fuel mixture in the combustion chamber, the control unit determines a recirculation rate for the re-circulated exhaust gas and adjusts a predetermined excess air ratio (λ) for the mixture composed of fresh air, re-circulated exhaust gas and fuel by means of the direct injection of fuel into the combustion chamber taking into account the recirculation rate in order to reduce the exhaust emissions of the internal combustion engine and improve fuel consumption.

This is a Continuation-In-Part Application of International Application PCT/EP2003/01432 filed Dec. 16, 2003 and claiming the priority of German Application 103 07 166.0 filed Feb. 20, 2003.

### BACKGROUND OF THE INVENTION

The invention relates to a method of operating a spark-ignition internal combustion engine wherein fuel can be supplied to the cylinders of the engine by direct injection into the combustion chambers and additionally through the air intake ducts of the internal combustion engine and the two fuel quantities are adjusted to one another as a function of the operating point of the internal combustion engine.

DE 199 45 544 A1 discloses a fuel supply system for a spark-ignition internal combustion engine in which fuel can be metered to each cylinder by direct injection of fuel into a combustion chamber through a blow-in valve arranged in the respective cylinder head or a direct injection valve and at least one further injection nozzle is provided in an intake region of the internal combustion engine for an additional injection of fuel. The direct injection of fuel into the combustion chamber and the feeding of fuel via the intake region are matched to one another by a control unit as a function of the operating point of the internal combustion engine. The control unit determines the respective flow rate through the nozzles assigned to the combustion chambers and through the additional fuel injection nozzles, in the intake region, and determines the respective quantities of fuel to be metered, so as to provide an ignitable fuel mixture in the combustion chamber.

The known method in which certain amounts of fuel can be injected directly into the combustion chambers and into the intake air in the intake region, are combined to form an internal mixture in accordance with the load of the engine. Direct metering of fuel into the combustion chamber is provided predominantly or exclusively in the idling range and the low load range, wherein a stratified charge operating mode with a mixture sequence with locally different fuel concentrations is provided by injecting fuel during the compression stroke of the respective cylinder. In the medium load range, a lean, homogenous mixture is fed via the intake duct of the internal combustion engine and, in addition, an internal mixture is formed so that the mixture provided in the intake region of the internal combustion engine, which is formed by intake manifold injection, is enriched so as to become ignitable. In the high load range, the mixture formation takes place by means of an intake manifold injection into the intake region and direct injection of fuel into the combustion chamber during the intake stroke, with a homogenous ignitable mixture being formed in the combustion chamber. Alternatively, with the known method, in the high load range the homogenous combustion engine charge can be provided exclusively by means of the intake manifold fuel injection into the intake.

The known operating method with a combination of internal mixture formation with direct injection of fuel into a combustion chamber and additional metering of fuel into an intake region of the internal combustion engine can bring about reduced nitrogen emissions of the internal combustion engine to an extent which was not previously achievable with exclusively internal fuel mixture formation, or could be achieved only with a substantial degree of complexity. However, the known method is no longer able to meet the increasingly stringent requirements made on modern internal combustion engines in terms of low emissions of pollutants in the exhaust gas of the internal combustion engine. Also, effective treatment of exhaust gas is still difficult, in particular during lean mixture engine operation.

It is the object of the present invention to provide a method of operating an internal combustion engine with fuel admixed to the intake air in the intake duct and also injected directly into the combustion chamber in such a way that the exhaust emissions of the internal combustion engine are reduced.

### SUMMARY OF THE INVENTION

In a method for operating a spark-ignition internal combustion engine, wherein fuel is metered into the cylinders by direct fuel injection into the combustion chambers and by the addition of fuel in an intake region of the engine and a control unit matches the quantity of fuel to be added in the intake region and the quantity of fuel to be injected directly into the combustion chamber to one another as a function of the operating point of the internal combustion engine so as to provide an ignitable fuel mixture in the combustion chamber, the control unit determines a recirculation rate for the re-circulated exhaust gas and adjusts a predetermined excess air ratio (λ) for the mixture composed of fresh air, re-circulated exhaust gas and fuel by means of the direct injection of fuel into the combustion chamber taking into account the recirculation rate in order to reduce the exhaust emissions of the internal combustion engine and improve fuel consumption.

With exhaust gas of the internal combustion engine re-circulated into the intake region, the control unit determines a recirculation rate of the exhaust gas, that is to say the proportion of re-circulated exhaust gas in the fresh gas which is ultimately fed into the combustion chamber. A predefined excess air ratio of the mixture composed of fresh air, exhaust gas and fuel is adjusted by directly injecting additional fuel into the combustion chamber taking into account the exhaust gas recirculation rate, with the control unit determining the quantity of fuel to be injected directly into the combustion chamber to provide the internal mixture formation. As a result of the adjustment of the excess air ratio of the fuel mixture by means of the direct injection of fuel into the combustion chamber, the exhaust gas compatibility of the combustion chamber charge is considerably improved so that, at high recirculation rates, the exhaust gas emissions of the internal combustion engine can be effectively increased during an operating method with combined metering of fuel by direct fuel injection into the combustion chamber and additional injection of fuel into the intake region. In this way, high recirculation rates can be combined with the formation of homogenous lean fuel mixtures in the combustion chamber and a low degree of throttling of the internal combustion engine in the partial load range can be achieved, permitting the consumption of fuel to be reduced.

According to the invention, a lean basic fuel mixture is enriched to the predetermined excess air mixture ratio in the combustion chamber by the direct injection of fuel, while the basic mixture is provided by the admixture of fuel to the intake air in the intake region that is by fuel injection into the intake manifold or by directly injecting fuel into the combustion chamber during the intake stroke of the internal combustion engine. A high exhaust gas compatibility in the mixture formation is obtained by the direct injection of fuel into the combustion chamber which results in a stabilization of the ignition of lean homogenous mixtures. A stabilizing effect on the ignition of even very lean homogenous fuel mixtures is obtained in particular if the direct injection of fuel for the purpose of achieving the provided excess air ratio in the combustion chamber takes place during the compression cycle.

A mixture with an excess air ratio in the stoichiometric range of λ=1 is advantageously formed at least in the upper load range of the internal combustion engine, as a result of which lower requirements in terms of exhaust gas treatment can be made even at high fuel throughput rates. As a result of the ignition injection into the combustion chamber during the compression cycle in combination with the exhaust gas recirculation, consumption advantages are also achieved. In one advantageous embodiment of the invention, the mixture formation is at least carried out predominantly by direct injection of metered fuel amounts into the combustion chamber during the compression stroke during operation of the internal combustion engine in lower load ranges. At higher operating loads, the system is switched to mixture formation with enrichment of a lean basic mixture to a stoichiometric excess air ratio by ignition injection. The switching over to the operating mode with stoichiometric mixture formation for higher operating loads is advantageously carried out with an average combustion chamber pressure of approximately 3.5 bar to 4.5 bar, preferably about 4.0 bar.

In one alternative embodiment of the invention, the internal combustion engine is operated in the entire load range with mixture formation with excess air coefficients in the stoichiometric range of λ=1. As a result, the necessary devices for the direct metering of fuel into the combustion chambers can be made physically smaller and simpler. Also, advantages can be obtained in terms of the quality of the fuel mixture, and the costs of the fuel supply system. The fuel consumption of the internal combustion engine can be improved as a result of reduced friction in the injection and metering devices. The operating mode according to the invention with mixture formation in the stoichiometric range over the entire load range of the internal combustion engine also makes it possible to changeover from previously customary piston compressors and piston pumps to cylinder-selective diaphragm compressors, diaphragm pumps or other pump/nozzle combinations or compressor/nozzle combinations for the metering of fuel. Furthermore, the direct ignition injection into the combustion chamber during the compression cycle in combination with exhaust gas recirculation in the full load operating mode of the internal combustion engine results in a turbulence increase in the combustion chamber, which has a positive effect on the combustion process, allowing the average combustion chamber pressure to be increased and the exhaust gas temperature to be reduced so that the exhaust gas emissions can be reduced. The quantity of fuel which is emitted directly into the combustion chamber during the compression cycle (ignition injection) is advantageously less than 20% of the overall quantity of fuel which is to be combusted and which is provided full load engine operation.

An exemplary embodiment of the invention will be described below in more detail with reference to the accompanying drawings:

### BRIEF DESCRIPTION OF THE DRAWINGS

FIG. 1 is a sectional view of an internal combustion engine with combined fuel supply by direct fuel injection into the combustion chamber and an additional supply of fuel via the intake region,

FIG. 2 is a graphic illustration of the engine power plotted against the rotational speed of the internal combustion engine according to a first method variant of mixture formation, and

FIG. 3 is a graphic illustration of the engine power plotted against the rotational speed according to an alternative method of mixture formation.

### DESCRIPTION OF ADVANTAGEOUS EMBODIMENTS OF THE INVENTION

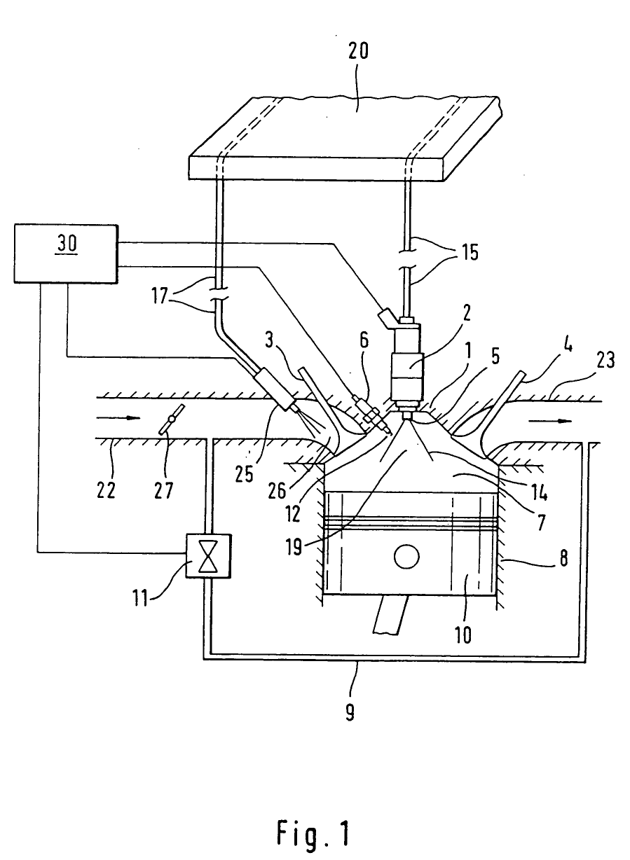

FIG. 1 is a sectional view of one of the cylinders 8 of an internal combustion engine, in which cylinder 8 a reciprocating piston 10 is arranged so as to be longitudinally movable. The piston 10 bounds a combustion chamber 7 which is closed off by a cylinder head 1 resting on the cylinder 8. Fuel is combusted with fresh gas in a known fashion in the combustion chamber 7 in order to expel the reciprocating piston 10. The fresh gas is sucked into the combustion chamber 7 via an intake manifold 22 which is controlled by an inlet valve 3. The exhaust gases are discharged via an exhaust valve or exhaust valves 4 into an exhaust gas manifold 23 after the combustion process. Preferably two exhaust or outlet valves 4 per cylinder 8 are provided in order to discharge the exhaust gases. The gas throughput rate of the intake line 22 can be controlled by a throttle valve 27. In order to reduce the emissions of pollutants by the internal combustion engine, exhaust gas is re-circulated through an exhaust gas recirculation line 9 which connects the exhaust gas manifold 23 to the intake manifold 22. In the present exemplary embodiment the exhaust gas recirculation line 9 opens into the intake region 26 of the intake manifold 22 downstream of the throttle valve 27 before the junction with the cylinder 8.

For the injection of the fuel which is needed for the combustion, a direct injection valve 2 is arranged in the cylinder head 1 of each cylinder. The direct injection valve 2 is able to inject fuel directly into the combustion chamber 7 via its injection nozzle 5. Each direct injection valve 2 of the cylinders 8 of the internal combustion engine is connected via a fuel port 15 to a distributor line 20 which may be a common pressure line (fuel rail). As an alternative to the direct injection by means of the direct injection valve 2, it is also possible to provide for fuel to be injected into the combustion chamber for internal mixture formation by means of a blow-in valve with which a fuel/medium mixture can be injected directly into the combustion chamber 7.

In addition to the direct injection of fuel into the combustion chamber 7, an injection valve 25 is provided in the intake region 26 of the intake manifold 22. This injection valve 25 is connected to the distributor line 20 via a fuel port 17 and, as part of the external mixture formation, injects fuel into the fresh gas before it enters the combustion chamber 7. With intake manifold injection for the external mixture formation, only a single injection valve 25 is needed in a common intake manifold 22 which serves all the cylinders 8 (single point injection). Alternatively, in each case one additional injection valve 25 may be assigned to each cylinder 8 of the internal combustion engine (multi-point injection).

Finally, a spark plug 6, which projects into the combustion chamber 7 and whose ignition electrodes are adjacent to a spray cone 14 of the fuel which is injected as a cone jet 19 by the injection nozzle 5 of the direct fuel injection valve 2, is arranged in the cylinder head 1. In a stratified charge operating mode of the internal combustion engine with locally different fuel concentrations in the combustion chamber it is ensured that the ignitable mixture passes between the electrodes 12 of the spark plug 6 in the region of the stratified mixture cloud in the cone jet 19.

The mixture composed of fuel and fresh gas and exhaust gas added to it as well as ultimately the ignition of the mixture in the combustion chamber 7 are controlled by a control unit 30 which matches the direct injection of fuel by the direct injection valve 2 and the additional intake manifold injection by the additional injection valve 25 in the intake region 26 as a function of the operating point of the internal combustion engine to one another and correspondingly actuates the direct injection valves 2 and the additional injection valve 25. The control unit 30 also determines the exhaust gas recirculation rate, i.e. the proportion of exhaust gas added to the fresh gas in the intake manifold 22 by correspondingly setting an exhaust gas recirculation valve 11 which is arranged in the exhaust gas recirculation line 9.

During the mixture formation a lean basic mixture is made available in the combustion chamber 7, which basic mixture is enriched with fuel to a predefined excess air ratio by fuel directly injected into the combustion chamber. The mixture composed of fresh air, exhaust gas and fuel which is formed in the combustion chamber is established by the control unit 30 which determines the direct injection of fuel into the combustion chamber in order to provide the proper mixture taking into account the recirculation rate, which is also determined by the control unit, with a view to obtaining the desired excess air ratio. A homogenous mixture is fed into the combustion chamber 7 as a lean basic mixture which is obtained by direct fuel injection. The homogenous mixture can be made available by intake manifold fuel injection or even by direct fuel injection during the intake cycle of the cylinder 8 as part of the internal mixture formation. Combinations of the external mixture formation and internal mixture formation in order to generate the homogenous basic mixture are also possible.

The setting of the excess air ratio during the mixture formation and the configuration of the mixture in the combustion chamber by the direct injection of fuel promotes the compatibility of added exhaust gases in the fresh gas, and a significant reduction in the emissions of pollutants is possible by means of high exhaust gas recirculation rates. By using devices for exhaust gas treatment in the exhaust gas line it is possible to combine the homogenous lean operating mode of the internal combustion engine with high exhaust gas recirculation rates, allowing the internal combustion engine to be operated in the partial load range in a largely un-throttled fashion.

If the fuel, which is to be injected directly into the combustion chamber in order to provide the desired excess air ratio, is injected as ignition injection during the compression cycle of the cylinder 8, stable ignition of even very lean, homogenous mixtures is promoted. Such an ignition injection also promotes exhaust gas compatibility of the fresh gas. The ignition injection according to the invention permits the exhaust gas compatibility of the fresh gas to be increased by more than 15% compared to intake manifold injection.

The control unit 30 advantageously sets an excess air ratio in the stoichiometric range of λ=1 by means of the quantity of fuel metered during the ignition injection, which, on the one hand, simplifies the exhaust gas treatment and, on the other hand, permits the direct injection valves 2 and the associated components to be made physically smaller and simplified in structural terms.

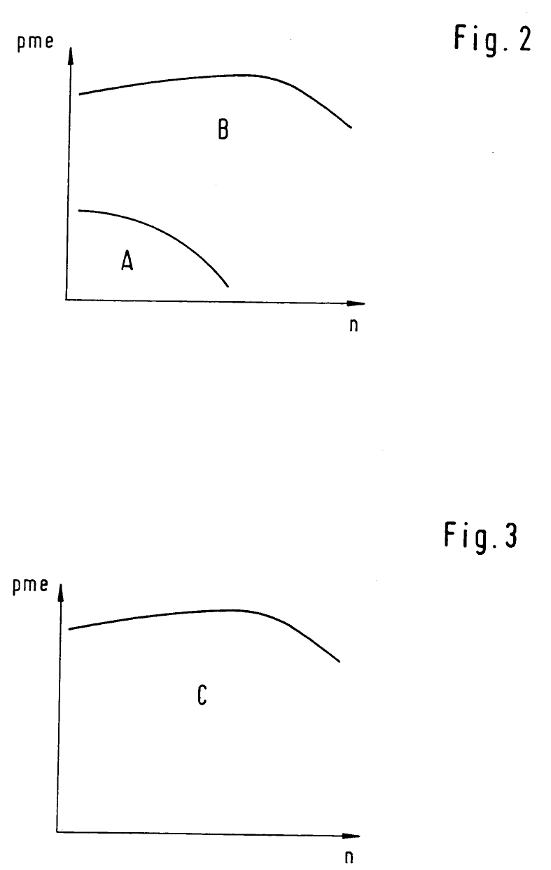

FIG. 2 shows a method variant of mixture formation where λ=1 which is provided in the operating mode B for the upper load range of the internal combustion engine. In this context, lean basic mixture is made available by means of intake manifold injection or intake manifold injection in combination with direct fuel injection during the intake cycle, and is enriched to the predetermined mixture ratio of λ=1 by ignition injection during the compression cycle. In the idling mode and in lower load ranges A, the metering of fuel is carried out at least predominantly by means of ignition injection into the combustion chamber 7 during the compression stroke with stratified charge and overall lean mixture formation. As an alternative to the exclusive metering of fuel by means of ignition injection in the operating mode A, it is also possible to make available a very lean basic mixture by means of intake manifold fuel injection and to generate a stratified and ignitable mixture by means of ignition injection during the compression stroke.

FIG. 3 shows a method variant for mixture formation in which mixture formation with a predefined excess air ratio in the stoichiometric range of λ=1 is provided in the entire operating range C of the internal combustion engine. A basic mixture is prepared by means of intake manifold injection or intake manifold injection in combination with direct fuel injection during the intake stroke of the respective cylinders and is established by ignition injection.

What is claimed is:

1. A method of operating a spark-ignition internal combustion engine having cylinders (8) with combustion chambers (7) into which fuel can be metered by direct fuel injection, an intake region (26) where fuel can be added and a control unit (30) which matches the quantity of fuel to be added in the intake region (26) and the quantity of fuel to be injected directly into the combustion chamber (7) as a function of the operating point of the internal combustion engine so as to provide an ignitable fuel mixture in the combustion chamber (7), said method comprising the steps of re-circulating exhaust gas from the internal combustion engine back into the intake region (26), wherein the control unit (30) determines a recirculation rate of the re-circulated exhaust gas and sets a predetermined excess air ratio (λ) for the mixture in the cylinder composed of fresh air, exhaust gas and fuel by means of ignition injection, that is late direct injection, of fuel into the combustion chamber (7) during the compression stroke taking into account the exhaust gas recirculation rate.

2. The method as claimed in claim 1, wherein a homogenous, lean mixture of fuel is formed in the combustion chamber (7).

3. The method as claimed in claim 1, wherein a lean basic mixture of fuel is provided by external mixture formation and is fed to the combustion chamber (7) via the intake region (26).

4. The method as claimed in claim 1, wherein the basic mixture of fuel is formed by direct metering of fuel into the combustion chamber (7) during the intake stroke of the engine.

5. The method as claimed in claim 1, wherein a mixture with an excess air ratio in the stoichiometric area of λ=1 is formed by the ignition injection during the compression stroke.

6. The method as claimed in claim 1, wherein, in the operating mode of the internal combustion engine in a lower load range, the air/fuel mixture is formed at least predominantly by ignition injection into the combustion chamber (7) during the compression cycle.

7. The method as claimed in claim 6, wherein the switching over to the operating mode with stoichiometric mixture formation (λ=1) for higher operating loads takes place in the medium load range with a medium combustion chamber pressure of approximately 3.5 bar to 4.5 bar, preferably 4.0 bar.

8. The method as claimed in claim 1, wherein the mixture formation with excess air coefficients in the stoichiometric range (λ=1) is provided in the entire load range of the internal combustion engine.

9. The method as claimed in claim 1, wherein the quantity of the fuel which is injected directly into the combustion chamber (7) during the compression cycle (the ignition injection) is less than 20% of the total quantity of fuel which is to be combusted and is provided during full engine operating load.
